(19) United States
(12) Patent Application Publication
(10) Pub. No.: US 2014/0103892 A1
(43) Pub. Date: Apr. 17, 2014

(54) SCALABLE MAXIMUM POWER POINT TRACKING CONTROLLERS AND ASSOCIATED METHODS

(71) Applicant: VOLTERRA SEMICONDUCTOR CORPORATION, Fremont, CA (US)

(72) Inventors: Michael D. McJimsey, Danville, CA (US); Vincent W. Ng, Milpitas, CA (US); Anthony J. Stratakos, Kentfield, CA (US); Ilija Jergovic, Palo Alto, CA (US); Xin Zhang, San Jose, CA (US); Kaiwei Yao, San Jose, CA (US)

(73) Assignee: VOLTERRA SEMICONDUCTOR CORPORATION, Fremont, CA (US)

(21) Appl. No.: 13/653,397

(22) Filed: Oct. 16, 2012

(51) Int. Cl. G05F 1/10

(52) U.S. Cl. 323/271

(57) ABSTRACT

A scalable maximum power point tracking (MPPT) controller includes an input and an output port, a switching circuit adapted to transfer power from the input port to the output port, and a controller core. The controller core is adapted to (a) control the switching circuit to maximize an amount of power extracted from a photovoltaic device electrically coupled to the input port, and (b) set one or more parameters of the MPPT controller based at least in part on a configuration code representing a number of photovoltaic cells of the photovoltaic device electrically coupled in series.

### BACKGROUND

Photovoltaic cells produce a voltage that varies with current, cell operating condition, cell physics, cell defects, and cell illumination. One mathematical model for a photovoltaic cell, as illustrated in FIG. 1, models output current as:

$$I = {I}_{L} - {I}_{0} \{ exp [ \frac{q ( V + IRs )}{nkT} ] - 1 \} - \frac{V + IRs}{{R}_{SH}} \qquad EQN . 1$$

### Where

I_{L}=photogenerated current

R_{S}=series resistance

R_{SH}=shunt resistance

I₀=reverse saturation current

n=diode ideality factor (1 for an ideal diode)

q=elementary charge

k=Boltzmann's constant

T=absolute temperature

I=output current at cell terminals

V=voltage at cell terminals

For silicon at 25° C., kT/q=0.0259 Volts.

Typical cell output voltages are low and depend on the band gap of the material used to manufacture the cell. Cell output voltages may be merely half a volt for silicon cells, far below the voltage needed to charge batteries or drive most other loads. Because of these low voltages, cells are typically connected together in series to form a module, or an array, having an output voltage much higher than that produced by a single cell. The number of series connected cells may vary, for example, based on the desired output voltage of the module or array. Additionally, a number of strings of series connected cells may be parallel connected to provide a desired current capability. An array, module, or other assembly of one or more photovoltaic cells may generally be referred to herein as a “photovoltaic device” for simplicity.

Real-world photovoltaic cells often have one or more microscopic defects. These cell defects may cause mismatches of series resistance R_{S}, shunt resistance R_{SH}, and photogenerated current I_{L} from cell to cell in a module. Further, cell illumination may vary from cell to cell in a system of photovoltaic cells, and may vary even from cell to cell in a module, for reasons including shadows cast by trees, bird droppings shadowing portions of a cell or module, dust, dirt, and other effects. These mismatches in illumination may vary from day to day and with time of day—a shadow may shift across a module during a day, and rain may wash away dust or dirt shadowing a cell.

From EQN. 1, output voltage is greatest at zero output current, and output voltage V falls off nonlinearly with increasing output current I. FIG. 2 illustrates the effect of increasing current drawn from a photovoltaic device at constant illumination. As current I is increased under constant illumination, voltage V falls off slowly, but as current I is increased to an output current near the photocurrent I_{L}, output voltage V falls off sharply. Similarly, cell power, the product of current and voltage, increases as current I increases, until falling voltage V overcomes the effect of increasing current, whereupon further increases in current I drawn from the cell cause power P to decrease rapidly. For a given illumination, each cell, module, and array of cells and modules therefore has a maximum power point (MPP) representing the voltage and current combination at which output power from the device is maximized. The MPP of a cell, module, or array will change as temperature and illumination, and hence photo-generated current I_{L}, changes. The MPP of a cell, module, or array may also be affected by factors such as shadowing and/or aging of the cell, module, or array.

Maximum Power Point Tracking (MPPT) controllers for operating a photovoltaic device at or near its maximum power point have been proposed. These controllers typically determine an MPP voltage and current for a photovoltaic device connected to their input, and adjust their effective impedance to maintain the photovoltaic device at the MPP.

### SUMMARY

In an embodiment, a scalable maximum power point tracking (MPPT) controller includes an input and an output port, a switching circuit adapted to transfer power from the input port to the output port, and a controller core. The controller core is adapted to (a) control the switching circuit to maximize an amount of power extracted from a photovoltaic device electrically coupled to the input port, and (b) set one or more parameters of the MPPT controller based at least in part on a configuration code representing a number of photovoltaic cells of the photovoltaic device electrically coupled in series.

In an embodiment, a scalable maximum power point tracking (MPPT) controller includes an input and an output port, a switching circuit adapted to transfer power from the input port to the output port, and a controller core. The controller core is adapted to (a) control the switching circuit to maximize an amount of power extracted from a photovoltaic device electrically coupled to the input port, and (b) set one or more parameters of the MPPT controller based at least in part on a configuration code representing a current characteristic of the photovoltaic device.

In an embodiment, a scalable maximum power point tracking (MPPT) controller includes an input and an output port, a switching circuit adapted to transfer power from the input port to the output port, and a controller core. The controller core is adapted to (a) control the switching circuit to maximize an amount of power extracted from a photovoltaic device electrically coupled to the input port, and (b) set one or more parameters of the MPPT controller based at least in part on a configuration code representing a reverse breakdown characteristic of the photovoltaic device.

In an embodiment, a method for operating a maximum power point tracking (MPPT) controller adapted to maximize an amount of power extracted from a photovoltaic device electrically coupled to an input port of the MPPT controller includes the following steps: (a) determining a configuration code of the MPPT controller, the configuration code representing a number of photovoltaic cells of the photovoltaic device electrically coupled in series, and (b) setting one or more parameters of the MPPT controller based at least in part on the configuration code.

In an embodiment, a method for operating a maximum power point tracking (MPPT) controller adapted to maximize an amount of power extracted from a photovoltaic device electrically coupled to an input port of the MPPT controller includes the following steps: (a) determining a configuration code of the MPPT controller, the configuration code representing a current characteristic of the photovoltaic device, and (b) setting one or more parameters of the MPPT controller based at least in part on the configuration code.

In an embodiment, a method for operating a maximum power point tracking (MPPT) controller adapted to maximize an amount of power extracted from a photovoltaic device electrically coupled to an input port of the MPPT controller includes the following steps: (a) determining a configuration code of the MPPT controller, the configuration code representing a reverse breakdown characteristic of the photovoltaic device, and (b) setting one or more parameters of the MPPT controller based at least in part on the configuration code.

### BRIEF DESCRIPTION OF THE DRAWINGS

FIG. 1 shows one model of a photovoltaic cell.

FIG. 2 shows a graph of voltage and power as a function of current for one photovoltaic cell.

FIG. 3 illustrates a scalable MPPT controller, according to an embodiment.

FIG. 4 illustrates an embodiment of the FIG. 3 MPPT controller scaled for high voltage operation.

FIG. 5 illustrates an embodiment of the FIG. 3 MPPT controller scaled for low voltage operation.

FIG. 6 schematically illustrates an electric power system including the MPPT controller of FIG. 3, according to an embodiment.

FIG. 7 shows one method of operating the MPPT controller of FIG. 3, according to an embodiment.

FIG. 8 shows divider circuitry programmable by a configuration code, according to an embodiment.

FIG. 9 shows a portion of a control subsystem for use in achieving MPPT by regulating input port voltage, according to an embodiment.

FIG. 10 shows an under voltage detection subsystem programmable by a configuration code, according to an embodiment.

FIG. 11 schematically illustrates an electric power system including a scalable MPPT controller configured as a boost converter, according to an embodiment.

FIG. 12 schematically illustrates an electric power system including multiple instances of the MPPT controller of FIG. 3, according to an embodiment.

FIG. 13 illustrates a method for determining a number of photovoltaic cells electrically coupled in series with an input port of an MPPT controller, according to an embodiment.

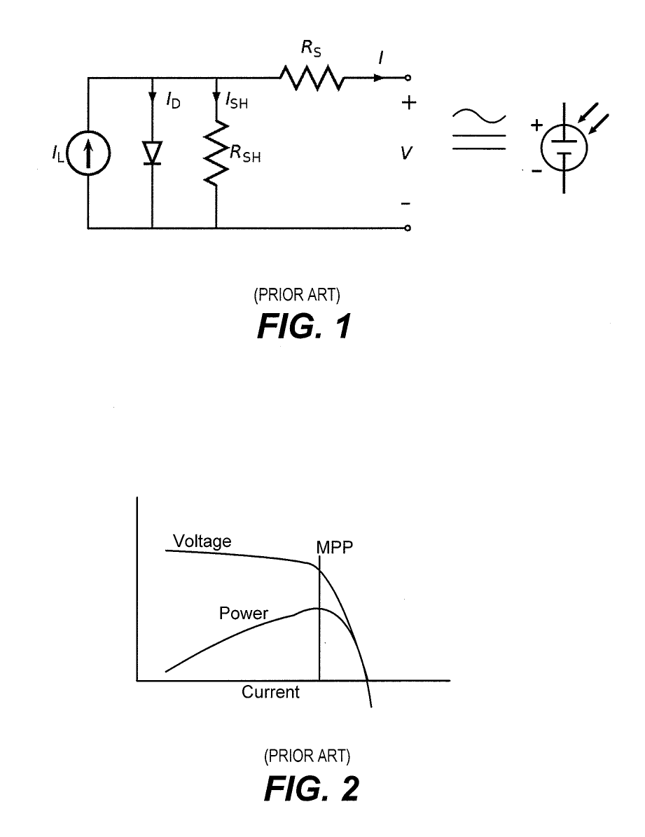

### DETAILED DESCRIPTION OF THE EMBODIMENTS

As discussed above, the number of photovoltaic cells electrically coupled in series and/or parallel in a photovoltaic device varies according to desired device voltage and/or current characteristics. For example, a photovoltaic device intended for high voltage applications will typically have a greater number of series coupled photovoltaic cells than a photovoltaic device intended for low voltage applications. Thus, photovoltaic device current-voltage characteristics can vary significantly according to photovoltaic device design. However, it is generally impractical to design an MPPT controller to accommodate a wide range of photovoltaic device electrical characteristics. For example, an MPPT controller's voltage and current ratings should typically be only as high as needed for use with an intended photovoltaic device, because excessively high ratings can reduce controller performance, increase controller cost, and/or increase controller complexity. As another example, ratio of control switching device size to freewheeling switching device size can often be optimized for an expected photovoltaic device voltage range.

Accordingly, an MPPT controller typically must be designed to support a particular range of photovoltaic device current-voltage characteristics. Applicants have developed MPPT controllers that can be scaled to support a range of photovoltaic device electrical-current characteristics, thereby facilitating MPPT controller customization.

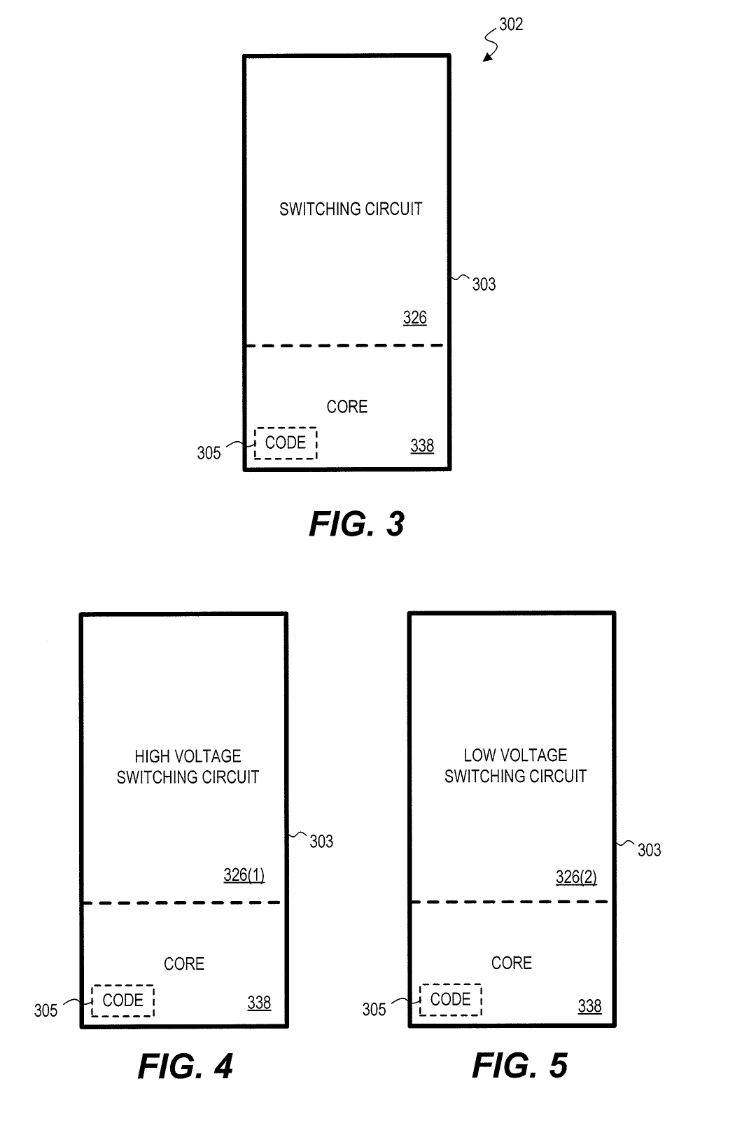

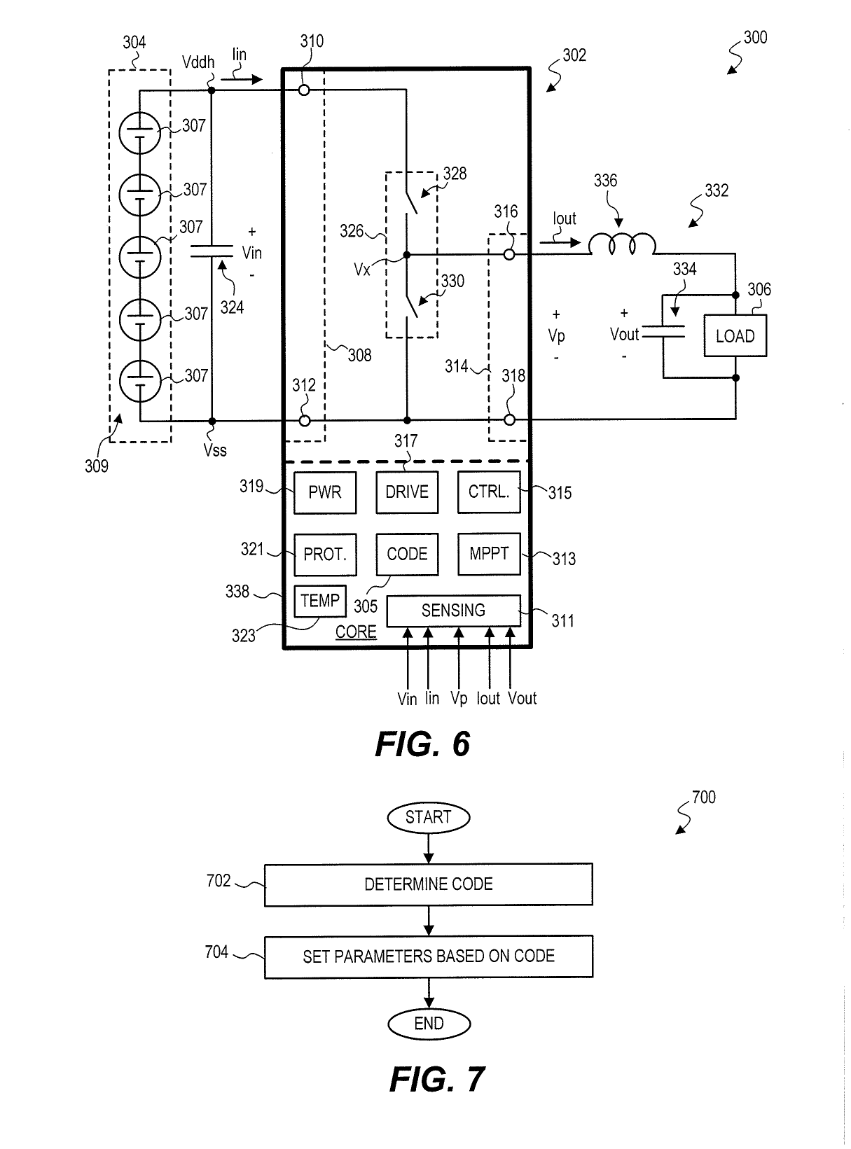

For example, FIG. 3 illustrates a scalable MPPT controller 302 which includes a switching circuit 326 and a controller core 338. As discussed below with respect to FIG. 6, switching circuit 326 includes control and freewheeling switching devices that repeatedly switch between their conductive and non-conductive states to transfer power from a photovoltaic device to load, while maximizing power extracted from the photovoltaic device. In this document, a switching device includes, but is not limited to, a bipolar junction transistor, a field effect transistor (e.g., an N-channel or P-channel metal oxide semiconductor field effect transistor (MOSFET) such as a laterally diffused metal oxide semiconductor transistor (LDMOS), a junction field effect transistor, a metal semiconductor field effect transistor), an insulated gate bipolar junction transistor, a thyristor, or a silicon controlled rectifier. Controller core 338 controls operation of MPPT controller 302, including operation of switching circuit 326. It is anticipated that in many embodiments, MPPT controller 302 is implemented in a single integrated circuit 303, as shown, such as to promote small size, small parasitic impedance between components, and fast signal transfer time. Furthermore, in some embodiments, switching circuit 326 and controller core 338 are part of a common integrated circuit chip. However, controller 302 is not limited to integrated circuit applications, and instead is formed partially or completely of discrete components in some other embodiments.

MPPT controller 302 is scalable in that it may incorporate any one of several different switching circuit 326 embodiments, thereby accommodating various photovoltaic device current-voltage characteristics, without requiring a change to controller core 338. Switching circuit 326 may be selected based on one or more characteristics of a photovoltaic device to be electrically coupled to controller 302, such as number of photovoltaic cells electrically coupled in series, photovoltaic device voltage, photovoltaic device reverse breakdown characteristics, and/or photovoltaic device current. Additionally, in some embodiments, switching circuit 326 may be changed without affecting the physical size of MPPT controller 302, thereby allowing standardization of controller packaging and placement.

For example, FIG. 4 illustrates an embodiment of controller 302 scaled for use with a photovoltaic device including a large number of photovoltaic cells electrically coupled in series. This embodiment includes a high voltage switching circuit 326(1) which is designed to withstand relatively high voltage operation, since a large number of series coupled photovoltaic cells will typically generate a relatively high voltage. In this document, specific instances of an item may be referred to by use of a numeral in parentheses (e.g., switching circuit 326(1)) while numerals without parentheses refer to any such item (e.g., switching circuits 326).

FIG. 5, on the other hand, illustrates an embodiment of controller 302 scaled for use with a photovoltaic device including a smaller number of photovoltaic cells electrically coupled in series. Thus, this embodiment includes a low voltage switching circuit 326(2), which is not necessarily capable of withstanding high voltage operation. Use of a low voltage switching circuit in place of a high voltage switching circuit, where feasible, may offer one or more advantages such as low cost or improved performance. For example, field effect transistors designed for low voltage operation sometimes have a lower channel resistance than field effect transistors designed for high voltage operation.

Controller core 338 is adapted to be compatible with a number of different switching circuit 326 embodiments, thereby potentially allowing a single base design of MPPT controller 302 to accommodate a range of photovoltaic devices simply by scaling switching circuit 326's voltage capability, current capability, and/or switching device size ratio, as appropriate. For example, a process used to form switching circuit 326 can be selected based on the required voltage rating of switching circuit 326, which is typically proportional to the number of series coupled photovoltaic cells. As another example, the size of switching circuit 326's switching devices may be selected based on the photovoltaic device's current capability. Furthermore, the ratio of control switching device size to freewheeling switching device size can be selected based on the expected nominal voltage conversion ratio of the intended application. For instance, where MPPT is desired with little voltage conversion ratio in buck converter embodiments, it is often desirable to increase control switching device size relative to freewheeling switching device size since the nominal duty cycle is high. However, if a larger voltage conversion ratio is required, such as to increase the number of panels that can be accommodated in a single voltage-constrained string, the freewheeling switching device size may be increased relative to the control switching device size. Such scalability may allow a single controller core to be used in a family of different MPPT controllers, even though required voltage, current, and nominal voltage conversion ratios may vary significantly over the family. Use of a single controller core among a controller family may reduce the need to design, manufacture, procure, and stock separate components for the various family members.

It is anticipated that in many embodiments, one or more parameters of MPPT controller 302 will be adjusted based on one or more characteristics of the photovoltaic device intended to be coupled to the controller. For example, an overvoltage threshold may be set higher in embodiments supporting a large number of series coupled cells than in embodiments supporting a small number of series coupled cells.

Accordingly, some embodiments of controller core 338 are programmable with an optional configuration code 305, which, for example, represents one or more characteristics of the photovoltaic device intended to be electrically coupled to MPPT controller 302. For instance, configuration code 305 may directly represent a number of series coupled photovoltaic cells, or the configuration code may indirectly represent the number of series coupled photovoltaic cells by representing one or more photovoltaic device electrical characteristics, such as open circuit voltage. Controller core 338 determines configuration code 305 and sets one or more MPPT controller 302 parameters based at least partially on the configuration code. For example, in a certain embodiment, configuration code 305 specifies a number of photovoltaic cells electrically coupled in series, and controller core 338 sets an overvoltage detection threshold value in proportion to the number of cells. As another example, in some embodiments, configuration code 305 specifies current characteristics of the photovoltaic device, such as device short circuit current, and/or photovoltaic device reverse breakdown characteristics.

In certain embodiments, configuration code 305 is stored in memory of controller core 338. However, controller core 338 need not necessarily include memory, and configuration code 305 may be represented in other manners, such as by the configuration of electrical conductors in controller core 338. For instance, in a certain embodiment, configuration code 305 is represented by electrical conductor configuration and adjusted by a metal change during integrated circuit 303 design. As another example, in some other embodiments, configuration code 305 is represented at least in part by a characteristic of one or more controller components, such as a resistance value of a resistor or a capacitance value of a capacitor. For instance, in some embodiments, controller core 338 determines the value of one or more components electrically coupled thereto using one or more of the systems and methods taught in U.S. Pat. No. 6,894,501 to Flasck et al., which is incorporated herein by reference.

It should be understood, though, that controller core 338 is not required to support a configuration code, and configuration code 305 and associated support is therefore omitted in some embodiments.

FIG. 6 schematically illustrates an electric power system 300 including MPPT controller 302 electrically coupled between a photovoltaic device 304 and a load 306. MPPT controller 302 includes an input port 308 and an output port 314. Input port 308 includes a high side input terminal 310 and a low side input terminal 312, and output port 314 includes a high side output terminal 316 and a low side output terminal 318. Photovoltaic device 304 is electrically coupled to input terminals 310, 312, such that photovoltaic device 304 is electrically coupled in series with input port 308. Terminal 310 forms part of a positive power node or rail (Vddh), and terminal 312 forms part of a reference power node or rail (Vss). Photovoltaic device 304 includes a number of photovoltaic cells 307 electrically coupled in series to form a string 309. The number of photovoltaic cells 307 in string 309 may be varied without departing from the scope hereof. One or more additional strings could also be coupled in parallel with string 309, and additional cells could be coupled in parallel with cells 307, without departing from the scope hereof. However, system 300 is not limited to photovoltaic applications. For example, in some alternate embodiments, photovoltaic device 304 is replaced with or supplemented by one or more alternative electric power sources, such as a fuel cell or a battery.

System 300 optionally includes one or more input capacitors 324 electrically coupled across input port 308. Capacitors 324 helps supply the ripple component of controller 302 input current Iin, thereby helping minimize the magnitude of ripple current flowing through photovoltaic device 304. Low ripple current magnitude through photovoltaic device 304, in turn, promotes efficient device operation. In certain embodiments where MPPT controller 302 switches at a relatively high frequency, such as at 500 kilohertz or greater, capacitors 324 are multilayer ceramic capacitors, to promote small capacitor size and long capacitor life.

Switching circuit 326 is electrically coupled across input port 308. Switching circuit 326 includes a control switching device 328 electrically coupled between high side input terminal 310 and high side output terminal 316, and a freewheeling switching device 330 electrically coupled between high side output terminal 316 and low side output terminal 318. High side output terminal 316 is electrically coupled to a switching node Vx joining switching devices 328, 330, and low side output terminal 318 is electrically coupled to low side input terminal 312.

Load 306 is electrically coupled in series with output port 314 to form part of an output circuit 332 electrically coupling load 306 to switching circuit 326. Load 306 includes, for example, an inverter or a battery charger. One or more output capacitors 334 are electrically coupled across load 306 to absorb the ripple component of output current Iout. Capacitors 334 are optionally omitted, though, in embodiments where load 306 includes significant capacitance, such as in embodiments where load 306 is an inverter with significant input capacitance. In certain embodiments where MPPT controller 302 switches at a relatively high frequency, such as at 500 kilohertz or greater, capacitors 334 are multilayer ceramic capacitors to promote small capacitor size and long capacitor life. Output circuit 332 includes energy storage inductance 336. In some embodiments, energy storage inductance 336 includes one or more discrete inductors, as symbolically shown in FIG. 3. However, in some other embodiments, discrete energy storage inductors are omitted, and “parasitic” interconnection inductance associated with output circuit 332 serves as energy storage inductance 336.

As discussed above, controller core 338 controls MPPT controller 302 operation. Switching circuit 326, energy storage inductance 336, and capacitors 334 collectively form a buck converter controlled by controller core 338. Controller core 338 is adapted to control switching of switching circuit 326 such that the buck converter transfers power from input port 308 to output port 314, thereby transferring power from photovoltaic device 304 to load 306. Specifically, control subsystem 338 causes control switching device 328 to repeatedly switch between its conductive and non-conductive states, typically at a frequency of at least 100 kilohertz, to transfer power from input port 308 to output port 314. Switching device 328 is referred to as the “control” switching device because the ratio of input voltage Vin across input port 308 to output voltage Vout across load 306 is a function of switching device 328's duty cycle.

Controller core 338 also controls switching of freewheeling switching device 330 such that it performs a freewheeling function, or in other words, such that freewheeling switching device 330 provides a path for output current Iout flowing between output terminals 316, 318 when control switching device 328 is in its non-conductive state. In some alternate embodiments, freewheeling switching device 330 is replaced with an alternative freewheeling device, such as a diode with its anode electrically coupled to reference node Vss and its cathode electrically coupled to switching node Vx.

Although input capacitors 324, output capacitors 334, and energy storage inductance 336 are shown as being external to MPPT controller 302, one or more of these components could be integrated within controller 302 without departing from the scope hereof. In some embodiments, MPPT controller 302 is co-packaged with photovoltaic device 304 to promote small system size and minimal impedance between device 304 and controller 302.

Controller core 338 causes control switching device 328 to repeatedly switch between its conductive and non-conductive states to at least substantially maximize an amount of power extracted from photovoltaic device 304 and delivered to load 306, in an MPPT operating mode of controller 302. For example, in some embodiments, controller core 338 maximizes power into input port 308, thereby maximizing power extracted from photovoltaic device 304. In some other embodiments, controller core 338 maximizes power out of output port 314, which effectively maximizes power extracted from photovoltaic device 304, since power out of output port 314 is the same as power into input port 308, neglecting losses in MPPT controller 302.

MPPT controller 302 may be configured to directly maximize input port or output port power in the MPPT operating mode. For example, in some embodiments, controller core 338 estimates input power from the product of input voltage Vin and input current Iin and controls switching circuit 326 to maximize input power. As another example, in some other embodiments, controller core 338 estimates output power from the product of output current Iout and output voltage Vout, or average value of output node voltage Vp, and controls switching circuit 326 to maximize output power. However, MPPT controller 302 may alternately be configured to maximize input or output port power by maximizing a signal related to input port or output port power. For example, in a particular embodiment where output current Iout is essentially constant, controller core 338 maximizes output port power by maximizing output voltage Vout, or an average value of output port/switching node voltage Vp.

MPPT controller 302 optionally includes one or more operating modes in addition to the MPPT operating mode. For example, some embodiments support a bypass operating mode, where controller core 338 causes control switching device 328 to continuously operate in its non-conductive state and freewheeling switching device 330 to continuously operate in its conductive state. Bypass mode support may be desired in applications where output port 314 is electrically coupled in series with other electric power sources, such as other instances of MPPT controller 302. In embodiments supporting the bypass operating mode, controller core 338 is configured, for example, to cause MPPT controller 302 to operate in its bypass mode when photovoltaic device 304 is producing enough power to support controller core 338, but not enough power to sustain MPPT operation.

Controller core 338 typically includes a number of blocks providing control or housekeeping functionality. For example, in the FIG. 6 embodiment, controller core 338 includes a sensing subsystem 311, an MPPT subsystem 313, control logic 315, driver circuitry 317, power supply circuitry 319, protection circuitry 321, as well as circuitry storing or representing configuration code 305. It should be appreciated, though, that the number and type of controller core blocks may be varied without departing from the scope hereof. For example, protection circuitry 321 is omitted in some alternate embodiments that do not require protection functionality.

Sensing subsystem 311 is adapted to sense one or more parameters for use by controller core 338 for purposes such as MPPT, voltage and/or current regulation, under and over voltage detection, and under and over current detection. For example, in some embodiments where MPPT is performed by maximizing input port 308 power, sensing subsystem 311 senses input voltage Vin and input current Iin to determine input port power. Some examples of parameters sensed by sensing subsystem 311 include, but are not limited to, input voltage Vin, input current In, output port voltage Vp, output current Iout, and/or output voltage Vout, as shown. However, the parameters sensed by sensing subsystem 311 may be varied without departing from the scope hereof.

MPPT subsystem 313 determines a MPP of photovoltaic device 304 and commands control logic 315 to operate control switching device 328 at a duty which achieves MPP operation. In the context of this document, a switch's duty cycle represents a portion of the switch's switching cycle that the switch is in its conductive state. For example, a switch that operates in its conductive state for eighty percent of its switching cycle is operating at eighty percent duty cycle. As another example, a switch that continuously operates in its conductive state is operating at one hundred percent duty cycle. MPPT subsystem 313 determines or estimates photovoltaic device power from one or more parameters sensed by sensing subsystem 311, and subsystem 313 adjusts duty cycle to maximize power. For example, in certain embodiments, MPPT subsystem 313 operates in a “perturb and observe” manner, where subsystem 313 repeatedly perturbs duty cycle and observes a corresponding change in photovoltaic device 304 power. In these embodiments, the direction of perturbation, i.e., an increase or decrease in duty cycle, is based on whether the previous perturbation increased or decreased power. For example, if the previous perturbation increased power, subsystem 313 again perturbs duty cycle in the same direction; otherwise, subsystem 313 perturbs duty cycle in the opposite direction.

Control logic 315 generates control signals to cause switching devices 328, 330 to switch between their conductive and non-conductive states, and driver circuitry 317 interfaces these control signals with switching devices 328, 330. For example, in certain embodiments, control logic 315 performs pulse-width-modulation of switching devices 328, 330, under command of MPPT subsystem 313, to cause switching circuit 326, energy storage inductance 336, and capacitors 334 collectively form a buck converter which maximizes power extracted from photovoltaic device 304. In certain embodiments where switching devices 328, 330 are field effect transistors, driver circuitry 317 converts control signals from control logic 315 to gate-to-source voltage signals to drive the transistors' gates.

Power supply circuitry 319 generates one or more power supply rails used by controller core 338, such as a “housekeeping” power supply rail Vcc from the Vddh/Vss power rails. Vcc is used, for example, to power one or more blocks of controller core 338. In some embodiments where control switching device 328 is an n-channel field effect transistor, power supply circuitry 319 also includes “bootstrap” circuitry to generate a transistor gate drive voltage referenced to switching node Vx.

Protection circuitry 321 provides one or more protection functions such as under voltage detection, over voltage detection, under current detection, over current detection, and/or over temperature protection. Protection circuitry 321 detects faults or abnormal conditions from one or more parameters sensed by sensing subsystem 311, and protection circuitry 321 commands control logic 315 to take action in response to a fault or abnormal condition. For example, in some embodiments, protection circuitry 321 monitors input voltage Vin and commands control logic 315 to increase control switching device 328's duty cycle to lower Vin, in response to Vin exceeding an over voltage threshold value.

Controller core 323 optionally includes a temperature sensor 323 adapted to generate temperature information representing temperature at MPPT controller 302. As discussed below, temperature information is used in certain embodiments to adjust photovoltaic device 304 voltage measurements for temperature. Temperature information is also used in certain embodiments to implement over temperature protection.

As discussed above, certain embodiments of controller core 338 set one or more MPPT controller 302 parameters based at least partially on configuration code 305. For example, FIG. 7 shows one method 700 of operating MPPT controller 302 in response to a configuration code 305, which is performed, for example, at start-up of MPPT controller 302. However, MPPT controller 302 could operate by methods other than method 700.

Method 700 begins with a step 702 of determining a configuration code of the MPPT controller. One example of step 702 is controller core 338 reading configuration code 305 from controller core memory, or controller core 338 determining configuration code 305 from an electrical conductor configuration or an electrical component characteristic. In step 704, one or more of the MPPT controller's parameters are set based at least partially on the configuration code. An example of step 704 is protection circuitry 321 adjusting a fault detection set point based on configuration code 305.

It is anticipated that in certain embodiments, numerous controller 302 parameters are set in response to configuration code 305. Discussed below are several examples of such parameters. However, alternative or additional parameters may be set by configuration code 305 without departing from the scope hereof.

Sensing subsystem 311 optionally includes divider circuitry to generate a signal proportional to input port voltage Vin and/or a signal proportional to output port voltage Vp, instead of directly providing these voltage signals to other controller core blocks. Controller core 338 may use signals representing Vin and/or Vp for regulation, MPPT, and/or protection purposes, for example. These signals typically have a magnitude proportional to, but smaller than, the magnitude of Vin and Vp, because other controller core blocks typically will not tolerate high voltage levels that are common on input port 308 and output port 314. Some embodiments of controller core 338 set the divider circuitry ratio, or in other words, the ratio of the divider output signal to divider input signal, in response to configuration core 305.

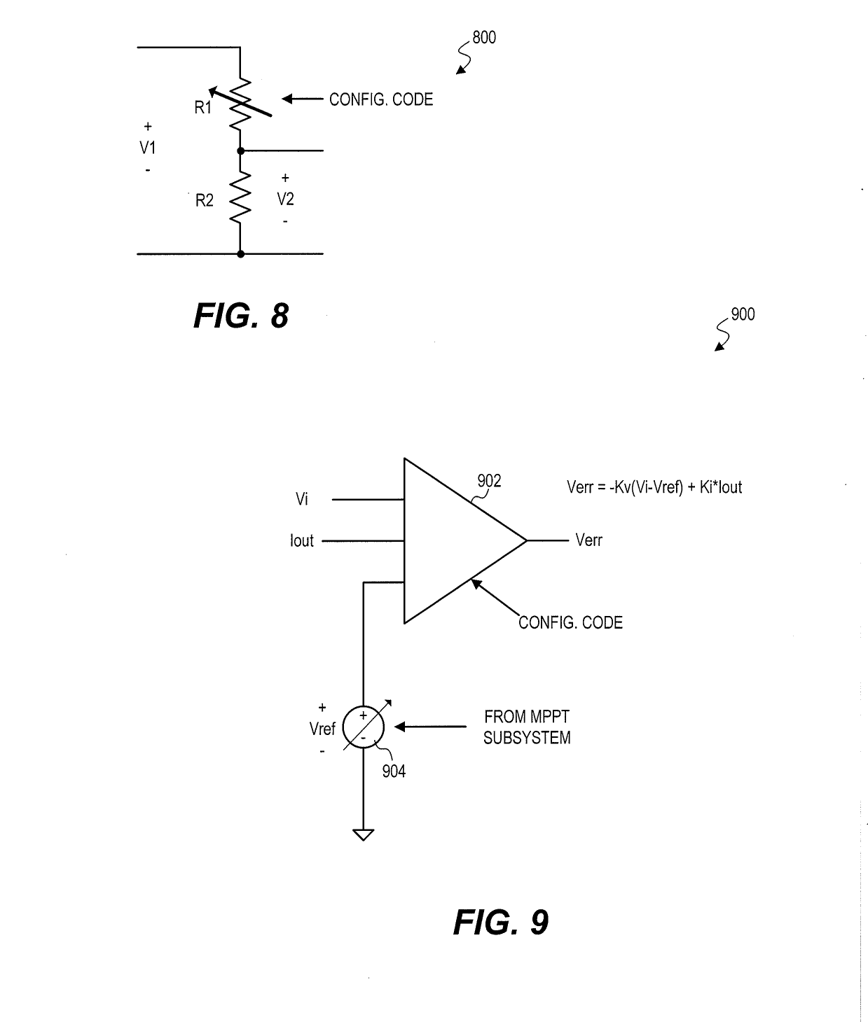

FIG. 8 shows one example of divider circuitry 800 implementing this principle. Circuitry 800 receives an input signal V1, which is, for example, Vin or Vp, and divides the input signal down to output signal V2, using a voltage divider including series connected resistors R1 and R2. Resistor R1 is set based on configuration code 305 so that the divider ratio, or the ratio of V2 over V1, is set based on the configuration code. Controller core 338 is typically adapted to set the divider ratio based on number of photovoltaic cells electrically coupled in series, as specified by configuration code 305. Specifically, controller core is typically configured so that the divider ratio is decreased as the number of series coupled cell increases, so that magnitude of signals generated by sensing subsystem 311 largely remain within a single range despite variations in number of series coupled cells.

Divider circuitry 800 could be modified such that resistor R2 is programmable in place of, or in addition to, R1. Additionally, sensing subsystem 311 could implement programmable divider circuitry other than a voltage divider, to potentially achieve improved performance.

Control logic 315 typically includes one or more closed loop control subsystems to regulate one or more aspects of MPPT controller 302 operation, such as input voltage Vin, input current In, input port 308 power, output voltage Vout, average value of output port voltage Vp, output current lout, and/or output port 314 power. As known in the art, closed loop control subsystems typically include one or more scaling factors, which are determined by component values in analog control systems or by programming instructions in digital control systems, to obtain desired control system parameters. It is often desirable, however, to change scaling factors as input voltage changes, such as to maintain a desired control subsystem bandwidth. Thus, certain embodiments of controller core 338 set closed loop control subsystem scaling factors in response to configuration code 305, such as to achieve a desired control system response as the number of series coupled photovoltaic cells increases or decreases, and/or as a photovoltaic device current characteristic, such as short circuit current rating, increases or decreases.

FIG. 9 shows a portion 900 of a control subsystem for use in an embodiment that achieves MPPT by regulating input port voltage Vin. It should be understood, however, that controller core 338 is not limited to using the control subsystem portion of FIG. 9 and may instead include alternative or additional control circuitry. Additionally, controller core 338 may regulate parameters other than, or in addition to, Vin.

Portion 900 includes an error signal generation circuitry 902 and a programmable voltage reference 904. MPPT subsystem 313 determines a Vin value required to achieve MPP operation and commands programmable voltage reference 904 to generate such voltage (Vref). Circuitry 902 generates an error signal (Verr) which includes two components, a voltage error signal −Kv(Vi−Vref) and a current signal Ki*Iout. Vi is an input voltage signal proportional to input port voltage Vin, Kv is a voltage scaling factor, Ki is a current scaling factor, and lout is current out of output port 314. Controller core 338 is adapted to scale Kv and Ki based on configuration code 305 so that control loop parameters remain roughly the same as photovoltaic device current-voltage characteristics change. Specifically, controller core 338 is adapted to scale Kv such that it is inversely proportional to a number of series coupled photovoltaic cells 307 electrically coupled to input port 308, as specified by configuration code 305. Additionally, controller core 338 is adapted to scale Ki such that it is inversely proportional to a short circuit current rating of a photovoltaic device 304 electrically coupled to input port 308, as specified by configuration code 305. In some embodiments, controller core 338 is adapted to scale Kv by changing a ratio of a divider that generates Vi by dividing down Vin, such as in a manner similar to that discussed above with respect to FIG. 8. Control logic 315 controls switching circuit 326 in response to error signal Verr to maximize power extracted from photovoltaic device 304.

As discussed above, some embodiments of protection subsystem 321 implement over voltage and/or under voltage detection on one or more of input port 308 and output port 314. The over voltage and under voltage threshold values are set, for instance, based at least partially on configuration code 305, such that the threshold values are scaled with number of photovoltaic cells 307, maximum expected Vin, or maximum desired average output voltage. In some embodiments, controller core 338 is adapted to prevent input voltage Vin or average output port voltage Vp from falling below an under voltage threshold value, and/or adapted to prevent input port voltage Vin or average output port voltage Vp from rising above an over voltage threshold value. Furthermore, in some embodiments, controller core 338 is adapted to maintain a MPP voltage of photovoltaic device 304, or voltage across input port 308, to within a range of values, which is set according to configuration code 305.

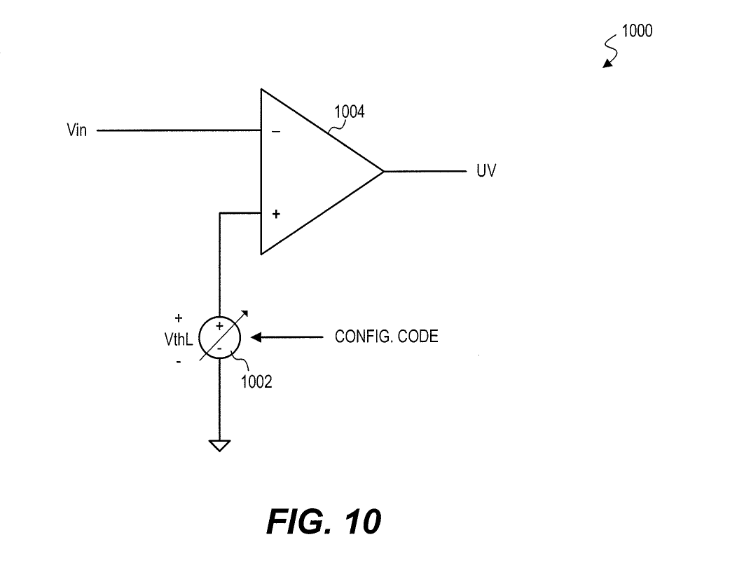

For example, FIG. 10 shows an under voltage detection subsystem 1000, which detects when input voltage Vin drops below a threshold value (VthL). VthL is generated by a voltage reference 1002, which is set by configuration code 305. A comparator 1004 asserts a signal UV in response to Vin dropping below VthL. Control logic 315 overrides MPPT subsystem 313 in response to UV and adjusts duty cycle of control switching device 328 to attempt to prevent Vin from falling further. An over voltage detection subsystem could be implemented in a similar manner.

It should be noted that limiting average voltage across output port 314 to a maximum threshold value, as supported in some embodiments, may allow string 309 to include more photovoltaic cell 307 instances than would otherwise be permissible under safety regulations. In particular, safety regulations often specify a maximum permissible photovoltaic string voltage, such as 600 volts or 1,000 volts. In the absence of maximum output voltage regulation, the maximum number of series coupled photovoltaic cells 307 is dictated by cell open circuit voltage. For example, consider a scenario where string voltage is limited to 600 volts, and each cell has a 0.5 volt open circuit voltage. In this scenario, no more than 1,200 cells can be series coupled while still complying with the safety regulations.

Limiting maximum average output port 314 voltage, however, potentially allows strings 309 to include additional photovoltaic cells 307, since maximum output voltage is determined by MPPT controller 302, instead of photovoltaic cell 307 open circuit voltage. For example, a maximum average voltage across output port 314 may be set based on expected MPP voltages of cells 307, instead of based on cell 307 open circuit voltage, thereby limiting output voltage with little or no impact of MPPT operation.

In certain embodiments, configuration code 305 represents, at least in part, reverse breakdown characteristics of photovoltaic device 304. In these embodiments, controller core 338 is adapted to determine from the reverse breakdown characteristics a minimum threshold voltage across input port 308, which prevents one or more of photovoltaic cells 307 from becoming reverse biased. Accordingly, controller core 338 is adapted to set the input port minimum threshold voltage based at least partially on reverse breakdown characteristics specified by configuration code 305, to prevent reverse breakdown of photovoltaic cells 307. Specifically, controller core 338 is adapted to detect when input port voltage Vin reaches this minimum threshold value and operate switching circuit 326 such that MPP voltage across input port 308 remains within a range of values that prevents cell 307 reverse breakdown. This reverse breakdown prevention feature potentially enables string 309 to include additional photovoltaic cells 307, and/or to include photovoltaic cells 307 having a lower breakdown voltage rating, than would otherwise be feasible without reverse breakdown protection.

As discussed above, some embodiments of protection subsystem 321 implement over current and/or under current detection on one or more of input port 308 and output port 314. The over current and under current threshold values are set, for instance, based at least partially on configuration code 305, such that the threshold values are scaled with current characteristics of photovoltaic device 304, such as a short circuit current rating of photovoltaic device 304. In some embodiments, controller core 338 is adapted to prevent a magnitude of current lout flowing through output port 314 from exceeding a maximum threshold value, where core 338 sets the maximum threshold value based at least in part on device 304 current characteristics, as specified by configuration code 305.

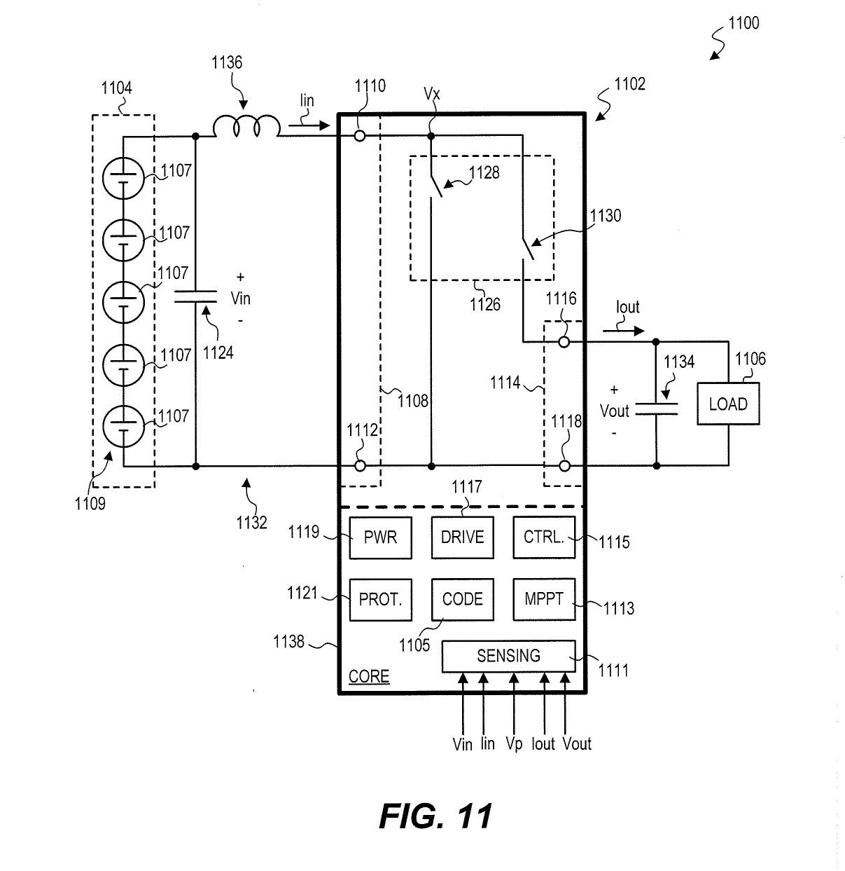

The scalable MPPT controllers discussed herein could be modified to support a topology other than a buck topology, such as a boost or buck-boost topology. For example, FIG. 11 schematically illustrates an electric power system 1100 including a scalable MPPT controller 1102, which supports a boost topology, electrically coupled between a photovoltaic device 1104 and a load 1106. MPPT controller 1102 includes a controller core 1138 and a switching circuit 1126. Switching circuit 1126 may be scaled depending on the characteristics of photovoltaic device 1104, and controller core 1138 is adapted to support a number of different embodiments of switching circuit 1126, in a manner similar to that discussed above with respect to FIGS. 3-5.

MPPT controller 1102 includes an input port 1108 and an output port 1114. Input port 1108 includes a high side input terminal 1110 and a low side input terminal 1112, and output port 1114 includes a high side output terminal 1116 and a low side output terminal 1118. Photovoltaic device 1104 is electrically coupled in series with input port 1108 via energy storage inductance 1136. Energy storage inductance 1136 includes one or more discrete inductors, as symbolically shown. However, in some alternative embodiments, energy storage inductance 1136 is instead parasitic inductance associated with an input circuit 1132 electrically coupling photovoltaic device 1104 to switching circuit 1126.

Photovoltaic device 1104 includes a number of photovoltaic cells 1107 electrically coupled in series to form a string 1109. The number of photovoltaic cells 1107 in string 1109 may be varied without departing from the scope hereof. One or more additional strings could also be coupled in parallel with string 1109, and/or additional cells could be coupled in parallel with cells 1107, without departing from the scope hereof. However, system 1100 is not limited to photovoltaic applications. For example, in some alternate embodiments, photovoltaic device 1104 is replaced with or supplemented by one or more alternative electric power sources, such as a fuel cell or a battery.

System 1100 optionally includes one or more input capacitors 1124 electrically coupled across photovoltaic device 1104. Capacitors 1124 helps supply the ripple component of controller 1102 input current Iin, thereby helping minimize the magnitude of ripple current flowing through photovoltaic device 1104. In certain embodiments where MPPT controller 1102 switches at a relatively high frequency, such as at 500 kilohertz or greater, capacitors 1124 are multilayer ceramic capacitors, to promote small capacitor size and long capacitor life.

Switching circuit 1126 is electrically coupled between input and output ports 1108, 1114. Switching circuit 1126 includes a control switching device 1128 electrically coupled between high side input terminal 1110 and low side input terminal 1112, and a freewheeling switching device 1130 electrically coupled between high side input terminal 1110 and high side output terminal 1116. High side input terminal 1110 is electrically coupled to a switching node Vx which joins switching devices 1128, 1130, and low side output terminal 1118 is electrically coupled to low side input terminal 1112.

Load 1106 is electrically coupled in series with output port 1114. Load 1106 includes, for example, an inverter or a battery charger. One or more output capacitors 1134 are electrically coupled across load 1106 to absorb the ripple component of output current Iout. Capacitors 1134 are optionally omitted, though, in embodiments where load 1106 includes significant capacitance, such as in embodiments where load 1106 is an inverter with significant input capacitance. In certain embodiments where MPPT controller 1102 switches at a relatively high frequency, such as at 500 kilohertz or greater, capacitors 1134 are multilayer ceramic capacitors to promote small capacitor size and long capacitor life.

Controller core 1138 controls MPPT controller 1102 operation. Switching circuit 1126, energy storage inductance 1136, and capacitors 1134 collectively form a boost converter controlled by controller core 1138. Controller core 1138 is adapted to control switching of switching circuit 1126 such that the boost converter transfers power from input port 1108 to output port 1114, thereby transferring power from photovoltaic device 1104 to load 1106. Specifically, controller core 1138 causes control switching device 1128 to repeatedly switch between its conductive and non-conductive states, typically at a frequency of at least 100 kilohertz, to transfer power from input port 1108 to output port 1114.

Controller core 1138 also controls switching of freewheeling switching device 1130 such that it performs a freewheeling function, or in other words, such that freewheeling switching device 1130 provides a path for current flowing between high side terminals 1110, 1116 when control switching device 1128 is in its non-conductive state. In some alternate embodiments, freewheeling switching device 1130 is replaced with an alternative freewheeling device, such as a diode with its anode electrically coupled to switching node Vx and its cathode electrically coupled to high side output terminal 1116.

Although input capacitors 1124, output capacitors 1134, and energy storage inductance 1136 are shown as being external to MPPT controller 1102, one or more of these components could be integrated within controller 1102 without departing from the scope hereof. In some embodiments, MPPT controller 1102 is co-packaged with photovoltaic device 1104 to promote small system size and minimal impedance between device 1104 and controller 1102.

In controller 1102's MPPT operating mode, controller core 1138 causes control switching device 1128 to repeatedly switch between its conductive and non-conductive states to at least substantially maximize an amount of power extracted from photovoltaic device 1104 and delivered to load 1106. For example, in some embodiments, control subsystem 1138 maximizes power into input port 1108, thereby maximizing power extracted from photovoltaic device 1104. In some other embodiments, control subsystem 1138 maximizes power out of output port 1114, which effectively maximizes power extracted from photovoltaic device 1104, since power out of output port 1114 is the same as power into input port 1108, neglecting losses in MPPT controller 1102.

Controller core 1138 typically includes blocks similar to those discussed above with respect to MPPT controller 302 of FIG. 3. For example, the FIG. 11 embodiment includes a sensing subsystem 1111, an MPPT subsystem 1113, control logic 1115, driver circuitry 1117, power supply circuitry 1119, protection circuitry 1121, as well circuitry storing or representing a configuration code 1105. These blocks are similar to corresponding blocks discussed above with respect to FIG. 3. It should be appreciated though, that the number and type of blocks may be varied without departing from the scope hereof.

Certain embodiments of controller core 1138 set one or more MPPT controller 1102 parameters based at least partially on configuration code 1105, in a manner similar to that discussed above with respect to MPPT controller 302. For example, certain embodiments of MPPT controller 1102 control one or more of a divider ratio, a closed loop control subsystem compensation factor, an under voltage threshold value, an over voltage threshold value, and/or a maximum power point voltage magnitude range based at least partially on configuration code 305.

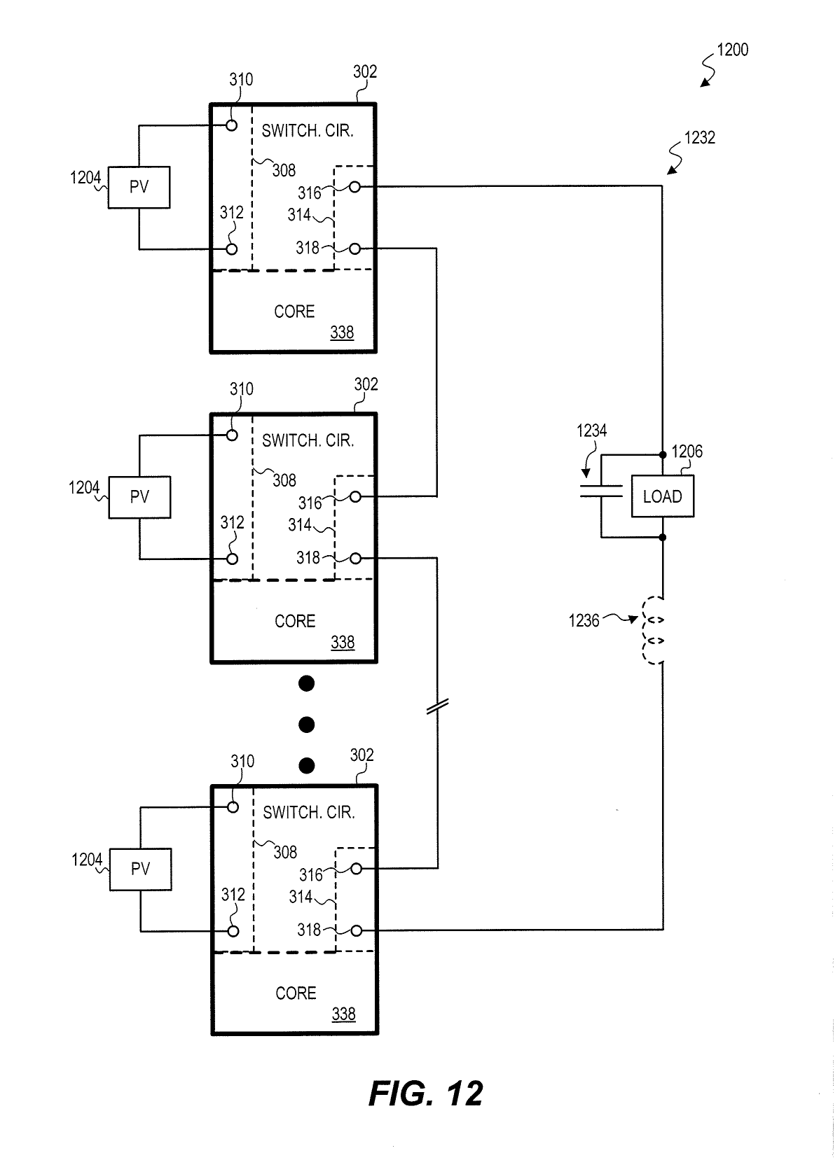

Certain of the scalable MPPT controllers disclosed herein may be used in applications requiring multiple MPPT controllers. For example, FIG. 12 schematically illustrates an electric power system 1200 including multiple instances of MPPT controller 302 of FIG. 3, with output ports 314 electrically coupled in series with a load 1206 and energy storage inductance 1236. Although energy storage inductance 1236 is symbolically shown as a single element, it is actually distributed interconnection inductance associated with an output circuit 1232 electrically coupling MPPT controllers 302 and load 1206. One or more output capacitors 1234 are electrically coupled in parallel with load 1206 to absorb ripple current generated by controllers 302. MPPT controllers 302 share energy storage inductance 1236 and output capacitors 1234. Some alternate embodiments, however, include one or more discrete inductors (not shown) electrically coupled in series with output circuit 1232 and/or additional output capacitors 1234. For example, each MPPT controller 302 is typically required to have a respective discrete inductor electrically coupled in series with its output port 314 in embodiments where each MPPT controller 302 has a respective capacitor electrically coupled across its output port 314.

A respective photovoltaic device 1204 is electrically coupled in series with each input port 308. Each photovoltaic device 1204 typically includes a number of photovoltaic cells (not shown) electrically coupled in series to form a string. MPPT controllers 302 operate in the same manner discussed above with respect to FIG. 6. Certain features of MPPT controllers 302 are not shown in FIG. 12 to promote illustrative clarity.

Some embodiment of the scalable MPPT controllers disclosed herein are adapted to at least partially determine their configuration code from one or more properties of a photovoltaic device electrically coupled thereto. For example, in certain embodiments of MPPT controller 302, controller core 338 is adapted to determine a number of cells 307 in string 309, and thereby determine at least a portion of configuration code 305. Specifically, controller core 338 is adapted to generate a first signal representing a voltage Vin across input port 308 while switching circuit 326 is in its inactive state, i.e., while both control and freewheeling switching devices 328, 330 are in their non-conductive states. The first signal is proportional to the sum of open circuit voltages of cells 307, and controller core 338 is adapted to determine the number of cells 307 in string 309 at least partially based on the first signal's magnitude.

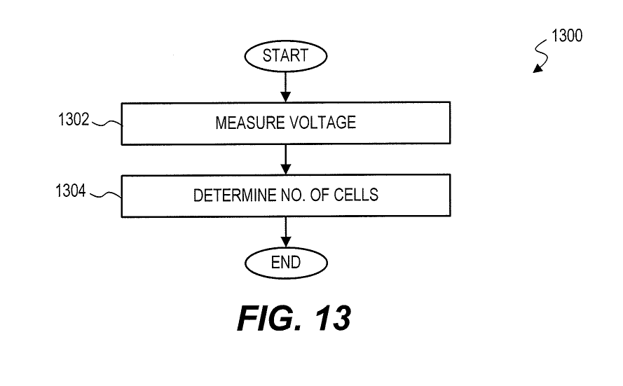

FIG. 13 illustrates a method 1300 of determining a number of photovoltaic cells electrically coupled in series with an MPPT controller's input port. Method 1300 is executed, for example, by certain embodiments of MPPT controller 302 to determine at least a portion of configuration code 305. In step 1302, a first signal representing a voltage across an input port of the MPPT controller is generated. An example of step 1302 is controller core 338 causing sensing subsystem 311 to generate a signal representing voltage Vin across input port 308 while control and freewheeling switching devices 328, 330 are in their non-conductive states. In step 1304, the number of series coupled photovoltaic cells is determined from the magnitude first signal. An example of step 1304 is controller core 338 comparing the signal generated in step 1302 to a lookup table correlating Vin to number of cells 307 in string 309. Table 1 below shows one example of a lookup table correlating Vin to number of cells 307 in string 309 in an embodiment where photovoltaic cells 307 have a nominal open circuit voltage of 0.5 volt.

TABLE 1

| Input Port Voltage (Vin) | Number of Cells 307 in String 309 |
|---|---|
| Vin ≦ 0.75 volts | 1 |
| 0.75 volts < Vin ≦ 1.25 volts | 2 |
| 1.25 volts < Vin ≦ 1.75 volts | 3 |
| 1.75 volts < Vin ≦ 2.25 volts | 4 |
| 2.25 volts < Vin ≦ 2.75 volts | 5 |

Additionally, in some embodiments, controller core 338 is adapted to cause temperature sensor 323 to measure the temperature at MPPT controller 302. Controller core 338 adjusts the first signal's magnitude based on temperature, as specified by temperature information from sensor 302, before determining the number of cells 307, thereby compensating for any open circuit voltage decrease due to high operating temperature.

Furthermore, some embodiments of the scalable MPPT controllers disclosed herein are adapted to determine if a photovoltaic device electrically coupled thereto is receiving sufficient illumination to sustain MPPT operation. For example, in some embodiments of MPPT controller 302, controller core 338 is adapted to measure a voltage across input port 308 while causing switching circuit 326 to pull current from photovoltaic device 304. A sufficiently large measured voltage across input port 308 indicates that device 304 is receiving sufficient illumination to support MPPT operation, while a small measured voltage indicates that device 304 is not receiving sufficient illumination to support MPPT operation. Accordingly, controller core 338 compares the measured voltage across input port 308 to a threshold value. If the measured voltage exceeds the threshold value, controller core 338 causes MPPT controller 302 to operate in its MPPT operation mode. On the other hand, if the measured voltage is less than or equal to the threshold value, controller core 302 causes MPPT controller 302 to operate in its bypass operating mode.

Combinations of Features

Features described above as well as those claimed below may be combined in various ways without departing from the scope hereof. The following examples illustrate some possible combinations:

(A1) A scalable maximum power point tracking (MPPT) controller may include an input and an output port, a switching circuit adapted to transfer power from the input port to the output port, and a controller core. The controller core may be adapted to (a) control the switching circuit to maximize an amount of power extracted from a photovoltaic device electrically coupled to the input port, and (b) set one or more parameters of the MPPT controller based at least in part on a configuration code representing a number of photovoltaic cells of the photovoltaic device electrically coupled in series.

(A2) In the scalable MPPT controller denoted as (A1), the controller core may be further adapted to (a) generate a first signal proportional to a voltage across the output port, for at least partially controlling the MPPT controller, and (b) set a ratio of the first signal to the voltage across the output port, based at least in part on the configuration code.

(A3) In either of the scalable MPPT controllers denoted as (A1) or (A2), the controller core may be further adapted to (a) generate a second signal proportional to a voltage across the input port, for at least partially controlling the MPPT controller, and (b) set a ratio of the second signal to the voltage across the input port, based at least in part on the configuration code.

(A4) In any of the scalable MPPT controllers denoted as (A1) through (A3), the controller core may include a closed loop control subsystem for at least partially controlling the MPPT controller, and the controller core may be further adapted to set at least one scaling factor of the closed loop control subsystem based at least in part on the configuration code.

(A5) In the scalable MPPT controller denoted as (A4), the controller core may be further adapted to (a) generate a voltage error signal proportional to a difference between an input voltage signal and a reference voltage signal, where the input voltage signal represents a voltage across the input port, and (b) scale the voltage error signal based at least in part on the configuration code.

(A6) In the scalable MPPT controller denoted as (A5), the controller core may include a divider subsystem adapted to generate the input voltage signal from the voltage across the input port, and the controller core may be further adapted to scale the voltage error signal at least in part by setting a ratio of the input voltage signal to the voltage across the input port.

(A7) In any of the scalable MPPT controllers denoted as (A1) through (A6), the controller core may be further adapted to (a) detect when a voltage across the input port is at a minimum threshold value, and (b) set the minimum threshold value based at least in part on the configuration code.

(A8) In any of the scalable MPPT controllers denoted as (A1) through (A7), the controller core may be further adapted to (a) detect when a voltage across the input port is at a maximum threshold value, and set the maximum threshold value based at least in part on the configuration code.

(A9) In any of the scalable MPPT controllers denoted as (A1) through (A8), the controller core may be further adapted to (a) maintain a magnitude of a maximum power point voltage across the input port to within a range of values, and (b) set the range of values based at least in part on the configuration code.

(A10) In any of the scalable MPPT controllers denoted as (A1) through (A9), the controller core may be further adapted to (a) prevent a magnitude of an average voltage across the output port from exceeding a second maximum threshold value, and (b) set the second maximum threshold value based at least in part on the configuration code.

(A11) In any of the scalable MPPT controllers denoted as (A1) through (A10), the controller core may include memory to store the configuration code.

(A12) In any of the scalable MPPT controllers denoted as (A1) through (A11), the configuration code may be represented at least in part by a configuration of electrical conductors of the controller core.

(A13) In any of the scalable MPPT controllers denoted as (A1) through (A12), the configuration code may be represented at least in part by a characteristic of one or more electrical components electrically coupled to the controller core.

(A14) In any of the scalable MPPT controllers denoted as (A1) through (A13), to controller core may be further adapted to receive the configuration code from an external source.

(A15) In any of the scalable MPPT controllers of denoted as (A1) through (A14), to controller core may be further adapted to (a) generate a third signal representing a voltage across the input port while the switching circuit is in an inactive state, and (b) determine the configuration code at least partially based on the third signal.

(A16) In the scalable MPPT controller denoted as (A15), the controller core may further include a temperature sensor, and the controller core may be adapted to adjust the third signal based at least in part on temperature information generated by the temperature sensor.

(A17) In any of the scalable MPPT controllers denoted as (A1) through (A16), the switching circuit and the controller core may be part of a common integrated circuit.

(A18) In any of the scalable MPPT controllers denoted as (A1) through (A17): (a) the input port may include a high side and a low side input terminal, (b) the output port may include a high side and a low side output terminal, and (c) the switching circuit may include: (1) a control switching device electrically coupled between the high side input terminal and the high side output terminal, and (2) a freewheeling switching device electrically coupled between the high side output terminal and the low side output terminal, where the low side input terminal is electrically coupled to the low side output terminal. The controller core may be further adapted to cause the control switching device to repeatedly switch between its conductive and non-conductive states to transfer power from the input port to the output port. The controller core may be further adapted to cause the freewheeling switching device to repeatedly switch between its conductive and non-conductive states to provide a path for current flowing between the high side output terminal and the low side output terminal when the control switching device is in its non-conductive state.

(B1) A scalable maximum power point tracking (MPPT) controller may include an input and an output port, a switching circuit adapted to transfer power from the input port to the output port, and a controller core. The controller core may be adapted to (a) control the switching circuit to maximize an amount of power extracted from a photovoltaic device electrically coupled to the input port, and (b) set one or more parameters of the MPPT controller based at least in part on a configuration code representing a current characteristic of the photovoltaic device.

(B2) In the scalable MPPT controller denoted as (B1), the current characteristic of the photovoltaic device may be a short circuit current rating of the photovoltaic device.

(B3) In either of the scalable MPPT controllers denoted as (B1) or (B2), the controller core may include a closed loop control subsystem for at least partially controlling the MPPT controller, and the controller core may be further adapted to set at least one scaling factor of the closed loop control subsystem based at least in part on the configuration code.

(B4) In the scalable MPPT controller denoted as (B3), the controller core may be further adapted to (a) generate a current signal proportional to current flowing out of the output port, (b) control the MPPT controller at least partially based on the current signal, and (c) scale the current signal based at least in part on the configuration code.

(B5) In any of the scalable MPPT controllers denoted as (B1) through (B4), the controller core may be further adapted to (a) prevent a magnitude of current flowing through the output port from exceeding a maximum threshold value, and (b) set the maximum threshold value based at least in part on the configuration code.

(B6) In any of the scalable MPPT controllers denoted as (B1) through (B5), the controller core may include memory to store the configuration code.

(B7) In any of the scalable MPPT controllers denoted as (B1) through (B6), the configuration code may be represented at least in part by a configuration of electrical conductors of the controller core.

(B8) In any of the scalable MPPT controllers denoted as (B1) through (B7), the configuration code may be represented at least in part by a characteristic of one or more electrical components electrically coupled to the controller core.

(B9) In any of the scalable MPPT controllers denoted as (B1) through (B8), to controller core may be further adapted to receive the configuration code from an external source.

(C1) A scalable maximum power point tracking (MPPT) controller may include an input and an output port, a switching circuit adapted to transfer power from the input port to the output port, and a controller core. The controller core may be adapted to (a) control the switching circuit to maximize an amount of power extracted from a photovoltaic device electrically coupled to the input port, and (b) set one or more parameters of the MPPT controller based at least in part on a configuration code representing a reverse breakdown characteristic of the photovoltaic device.

(C2) In the scalable MPPT controller denoted as (C1), the controller core may be further adapted to (a) detect when a voltage across the input port is at a minimum threshold value, and (b) set the minimum threshold value based at least in part on the configuration code.

(C3) In either of the scalable MPPT controllers denoted as (C1) or (C2), the controller core may be further adapted to (a) maintain a magnitude of a maximum power point voltage across the input port to within a range of values, and (b) set the range of values based at least in part on the configuration code.

(C4) In any of the scalable MPPT controllers denoted as (C1) through (C3), the controller core may include memory to store the configuration code.

(C5) In any of the scalable MPPT controllers denoted as (C1) through (C4), the configuration code may be represented at least in part by a configuration of electrical conductors of the controller core.

(C6) In any of the scalable MPPT controllers denoted as (C1) through (C5), the configuration code may be represented at least in part by a characteristic of one or more electrical components electrically coupled to the controller core.

(C7) In any of the scalable MPPT controllers denoted as (C1) through (C6), to controller core may be further adapted to receive the configuration code from an external source.

(D1) A method for operating a maximum power point tracking (MPPT) controller adapted to maximize an amount of power extracted from a photovoltaic device electrically coupled to an input port of the MPPT controller may include the following steps: (a) determining a configuration code of the MPPT controller, the configuration code representing a number of photovoltaic cells of the photovoltaic device electrically coupled in series, and (b) setting one or more parameters of the MPPT controller based at least in part on the configuration code.

(D2) The method denoted as (D1) may further include (a) generating a first signal proportional to a voltage across an output port of the MPPT controller, for at least partially controlling the MPPT controller, and (b) setting a ratio of the first signal to the voltage across the output port based at least in part on the configuration code.

(D3) Either of the methods denoted as (D1) or (D2) may further include (a) generating a second signal proportional to a voltage across the input port, for at least partially controlling the MPPT controller, and (b) setting a ratio of the second signal to the voltage across the input port based at least in part on the configuration code.

(D4) Any of the methods denoted as (D1) through (D3) may further include (a) at least partially controlling the MPPT controller using a closed loop control subsystem, and (b) setting at least one scaling factor of the closed loop control subsystem based at least in part on the configuration code.

(D5) The method denoted as (D4) may further include (a) generating a voltage error signal proportional to a difference between an input voltage signal and a reference voltage signal, the input voltage signal representing a voltage across the input port, and (b) scaling the voltage error signal based at least in part on the configuration code.

(D6) The method denoted as (D5) may further include (a) generating the input voltage signal from a voltage across the input port, and (b) scaling the voltage error signal at least in part by setting a ratio of the input voltage signal to the voltage across the input port.

(D7) Any of the methods denoted as (D1) through (D6) may further include (a) detecting when a voltage across the input port is at a minimum threshold value, and (b) setting the minimum threshold value based at least in part on the configuration code.

(D8) Any of the methods denoted as (D1) through (D7) may further include (a) detecting when a voltage across the input port is at a maximum threshold value, and (b) setting the maximum threshold value based at least in part on the configuration code.

(D9) Any of the methods denoted as (D1) through (D8) may further include (a) maintaining a magnitude of a maximum power point voltage across the input port to within a range of values, and (b) setting the range of values based at least in part on the configuration code.

(D10) Any of the methods denoted as (D1) through (D9) may further include (a) preventing a magnitude of an average voltage across an output port of the MPPT controller from exceeding a second maximum threshold value, and (b) setting the second maximum threshold value based at least in part on the configuration code.

(D11) Any of the methods denoted as (D1) through (D10) may further include storing the configuration code in memory of MPPT controller.

(D12) Any of the methods denoted as (D1) through (D11) may further include representing the configuration code at least partially by a configuration of electrical conductors of the MPPT controller.

(D13) Any of the methods denoted as (D1) through (D12) may further include representing the configuration code at least partially by a characteristic of one or more electrical components of the MPPT controller.

(D14) Any of the methods denoted as (D1) through (D13) may further include receiving the configuration code at the MPPT controller from an external source.

(D15) Any of the methods denoted as (D1) through (D14) may further include (a) generating a third signal representing a voltage across the input port while a switching circuit of the MPPT controller is in an inactive state, and (b) determining the configuration code at least partially based on the third signal.

(D16) The method denoted as (D15) may further include (a) measuring a temperature at the MPPT controller, and (b) prior to the step of determining the configuration code at least partially based on the third signal, adjusting the third signal based at least in part on the temperature at the MPPT controller.

(D17) Any of the methods denoted as (D1) through (D16) may further include (a) measuring a voltage across the input port while pulling current from the photovoltaic device, and (b) operating the MPPT controller in a MPPT operating mode if the voltage across the input port exceeds a second minimum threshold value.

(D18) The method denoted as (D17) may further include operating the MPPT controller in a bypass operating mode if the voltage across the input port is less than or equal to the second minimum threshold value.

(E1) A method for operating a maximum power point tracking (MPPT) controller adapted to maximize an amount of power extracted from a photovoltaic device electrically coupled to an input port of the MPPT controller may include the steps of (a) determining a configuration code of the MPPT controller, the configuration code representing a current characteristic of the photovoltaic device, and (b) setting one or more parameters of the MPPT controller based at least in part on the configuration code.

(E2) In the method denoted as (E1), the current characteristic of the photovoltaic device may be a short circuit current rating of the photovoltaic device.

(E3) Either of the methods denoted as (E1) or (E2) may further include (a) at least partially controlling the MPPT controller using a closed loop control subsystem, and (b) setting at least one scaling factor of the closed loop control subsystem based at least in part on the configuration code.

(E4) The method denoted as (E3) may further include (a) generating a current signal proportional to current flowing out of an output port of the MPPT controller, (b) controlling the MPPT controller at least partially based on the current signal, and (c) scaling the current signal based at least in part on the configuration code.

(E5) Any of the methods denoted as (E1) through (E5) may further include (a) preventing a magnitude of current flowing out of an output port of the MPPT controller from exceeding a maximum threshold value, and (b) setting the maximum threshold value based at least in part on the configuration code.

(E6) Any of the methods denoted as (E1) through (E5) may further include storing the configuration code in memory of MPPT controller.

(E7) Any of the methods denoted as (E1) through (E6) may further include representing the configuration code at least partially by a configuration of electrical conductors of the MPPT controller.

(E8) Any of the methods denoted as (E1) through (E7) may further include representing the configuration code at least partially by a characteristic of one or more electrical components of the MPPT controller.

(E9) Any of the methods denoted as (E1) through (E8) may further include receiving the configuration code at the MPPT controller from an external source.

(F1) A method for operating a maximum power point tracking (MPPT) controller adapted to maximize an amount of power extracted from a photovoltaic device electrically coupled to an input port of the MPPT controller may include the steps of (a) determining a configuration code of the MPPT controller, the configuration code representing a reverse breakdown characteristic of the photovoltaic device, and (b) setting one or more parameters of the MPPT controller based at least in part on the configuration code.

(F2) The method denoted as (F1) may further include (a) detecting when a voltage across the input port is at a minimum threshold value, and (b) setting the minimum threshold value based at least in part on the configuration code.

(F3) Either of the methods denoted as (F1) or (F2) may further include (a) maintaining a magnitude of a maximum power point voltage across the input port to within a range of values, and (b) setting the range of values based at least in part on the configuration code.

(F4) Any of the methods denoted as (F1) through (F3) may further include storing the configuration code in memory of MPPT controller.

(F5) Any of the methods denoted as (F1) through (F4) may further include representing the configuration code at least partially by a configuration of electrical conductors of the MPPT controller.

(F6) Any of the methods denoted as (F1) through (F5) may further include representing the configuration code at least partially by a characteristic of one or more electrical components of the MPPT controller.

(F7) Any of the methods denoted as (F1) through (F6) may further include receiving the configuration code at the MPPT controller from an external source.

Changes may be made in the above methods and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A scalable maximum power point tracking (MPPT) controller, comprising:
an input and an output port;
a switching circuit adapted to transfer power from the input port to the output port; and
a controller core adapted to:
control the switching circuit to maximize an amount of power extracted from a photovoltaic device electrically coupled to the input port, and
set one or more parameters of the MPPT controller based at least in part on a configuration code representing a number of photovoltaic cells of the photovoltaic device electrically coupled in series.

2. The scalable MPPT controller of claim 1, the controller core further adapted to:
generate a first signal proportional to a voltage across the output port, for at least partially controlling the MPPT controller; and
set a ratio of the first signal to the voltage across the output port, based at least in part on the configuration code.

3. The scalable MPPT controller of claim 2, the controller core further adapted to:
generate a second signal proportional to a voltage across the input port, for at least partially controlling the MPPT controller; and
set a ratio of the second signal to the voltage across the input port, based at least in part on the configuration code.

4. The scalable MPPT controller of claim 1, the controller core including a closed loop control subsystem for at least partially controlling the MPPT controller, the controller core further adapted to set at least one scaling factor of the closed loop control subsystem based at least in part on the configuration code.

5. The scalable MPPT controller of claim 4, the controller core further adapted to:
generate a voltage error signal proportional to a difference between an input voltage signal and a reference voltage signal, the input voltage signal representing a voltage across the input port; and
scale the voltage error signal based at least in part on the configuration code.

6. The scalable MPPT controller of claim 5, the controller core including a divider subsystem adapted to generate the input voltage signal from the voltage across the input port, the controller core further adapted to scale the voltage error signal at least in part by setting a ratio of the input voltage signal to the voltage across the input port.

7. The scalable MPPT controller of claim 1, the controller core further adapted to:
detect when a voltage across the input port is at a minimum threshold value; and
set the minimum threshold value based at least in part on the configuration code.

8. The scalable MPPT controller of claim 1, the controller core further adapted to:
detect when a voltage across the input port is at a maximum threshold value; and
set the maximum threshold value based at least in part on the configuration code.

9. The scalable MPPT controller of claim 1, the controller core further adapted to:
maintain a magnitude of a maximum power point voltage across the input port to within a range of values; and
set the range of values based at least in part on the configuration code.

10. The scalable MPPT controller of claim 1, the controller core further adapted to:
prevent a magnitude of an average voltage across the output port from exceeding a maximum threshold value; and
set the maximum threshold value based at least in part on the configuration code.

11. The scalable MPPT controller of claim 1, the controller core comprising memory to store the configuration code.

12. The scalable MPPT controller of claim 1, the configuration code being represented at least in part by a configuration of electrical conductors of the controller core.

13. The scalable MPPT controller of claim 1, the configuration code being represented at least in part by a characteristic of one or more electrical components electrically coupled to the controller core.

14. The scalable MPPT controller of claim 1, to controller core further adapted to receive the configuration code from an external source.

15. The scalable MPPT controller of claim 1, to controller core further adapted to:
generate a first signal representing a voltage across the input port while the switching circuit is in an inactive state; and
determine the configuration code at least partially based on the first signal.

16. The scalable MPPT controller of claim 15, the controller core further comprising a temperature sensor, wherein the controller core is adapted to adjust the first signal based at least in part on temperature information generated by the temperature sensor.

17. The scalable MPPT controller of claim 1, the switching circuit and the controller core being part of a common integrated circuit.

18. The scalable MPPT controller of claim 17, wherein:
the input port comprises a high side and a low side input terminal;
the output port comprises a high side and a low side output terminal;
the switching circuit comprises:
a control switching device electrically coupled between the high side input terminal and the high side output terminal, and
a freewheeling switching device electrically coupled between the high side output terminal and the low side output terminal;
the low side input terminal is electrically coupled to the low side output terminal;
the controller core is adapted to cause the control switching device to repeatedly switch between its conductive and non-conductive states to transfer power from the input port to the output port; and
the controller core is adapted to cause the freewheeling switching device to repeatedly switch between its conductive and non-conductive states to provide a path for current flowing between the high side output terminal and the low side output terminal when the control switching device is in its non-conductive state.

19. A scalable maximum power point tracking (MPPT) controller, comprising:
an input and an output port;
a switching circuit adapted to transfer power from the input port to the output port; and
a controller core adapted to:
control the switching circuit to maximize an amount of power extracted from a photovoltaic device electrically coupled to the input port, and
set one or more parameters of the MPPT controller based at least in part on a configuration code representing a current characteristic of the photovoltaic device.

20. The scalable MPPT controller of claim 19, the current characteristic of the photovoltaic device being a short circuit current rating of the photovoltaic device.

21. The scalable MPPT controller of claim 19, the controller core including a closed loop control subsystem for at least partially controlling the MPPT controller, the controller core further adapted to set at least one scaling factor of the closed loop control subsystem based at least in part on the configuration code.

22. The scalable MPPT controller of claim 21, the controller core further adapted to:
generate a current signal proportional to current flowing out of the output port;
control the MPPT controller at least partially based on the current signal; and
scale the current signal based at least in part on the configuration code.

23. The scalable MPPT controller of claim 19, the controller core further adapted to:
prevent a magnitude of current flowing through the output port from exceeding a maximum threshold value; and
set the maximum threshold value based at least in part on the configuration code.

24. The scalable MPPT controller of claim 19, the controller core comprising memory to store the configuration code.

25. The scalable MPPT controller of claim 19, the configuration code being represented at least in part by a configuration of electrical conductors of the controller core.

26. The scalable MPPT controller of claim 19, the configuration code being represented at least in part by a characteristic of one or more electrical components electrically coupled to the controller core.

27. The scalable MPPT controller of claim 19, to controller core further adapted to receive the configuration code from an external source.

28. A scalable maximum power point tracking (MPPT) controller, comprising:
an input and an output port;
a switching circuit adapted to transfer power from the input port to the output port; and
a controller core adapted to:
control the switching circuit to maximize an amount of power extracted from a photovoltaic device electrically coupled to the input port, and
set one or more parameters of the MPPT controller based at least in part on a configuration code representing a reverse breakdown characteristic of the photovoltaic device.

29. The scalable MPPT controller of claim 28, the controller core further adapted to:
detect when a voltage across the input port is at a minimum threshold value; and
set the minimum threshold value based at least in part on the configuration code.

30. The scalable MPPT controller of claim 28, the controller core further adapted to:
maintain a magnitude of a maximum power point voltage across the input port to within a range of values; and
set the range of values based at least in part on the configuration code.

31. The scalable MPPT controller of claim 28, the controller core comprising memory to store the configuration code.

32. The scalable MPPT controller of claim 28, the configuration code being represented at least in part by a configuration of electrical conductors of the controller core.

33. The scalable MPPT controller of claim 28, the configuration code being represented at least in part by a characteristic of one or more electrical components electrically coupled to the controller core.

34. The scalable MPPT controller of claim 28, to controller core adapted to receive the configuration code from an external source.

35. A method for operating a maximum power point tracking (MPPT) controller adapted to maximize an amount of power extracted from a photovoltaic device electrically coupled to an input port of the MPPT controller, comprising:
determining a configuration code of the MPPT controller, the configuration code representing a number of photovoltaic cells of the photovoltaic device electrically coupled in series; and
setting one or more parameters of the MPPT controller based at least in part on the configuration code.

36. The method of claim 35, further comprising:
generating a first signal proportional to a voltage across an output port of the MPPT controller, for at least partially controlling the MPPT controller; and
setting a ratio of the first signal to the voltage across the output port based at least in part on the configuration code.

37. The method of claim 36, further comprising:
generating a second signal proportional to a voltage across the input port, for at least partially controlling the MPPT controller; and
setting a ratio of the second signal to the voltage across the input port based at least in part on the configuration code.

38. The method of claim 35, further comprising:
at least partially controlling the MPPT controller using a closed loop control subsystem; and
setting at least one scaling factor of the closed loop control subsystem based at least in part on the configuration code.

39. The method of claim 38, further comprising:
generating a voltage error signal proportional to a difference between an input voltage signal and a reference voltage signal, the input voltage signal representing a voltage across the input port; and
scaling the voltage error signal based at least in part on the configuration code.

40. The method of claim 39, further comprising:
generating the input voltage signal from a voltage across the input port; and
scaling the voltage error signal at least in part by setting a ratio of the input voltage signal to the voltage across the input port.

41. The method of claim 35, further comprising:
detecting when a voltage across the input port is at a minimum threshold value; and
setting the minimum threshold value based at least in part on the configuration code.

42. The method of claim 35, further comprising:
detecting when a voltage across the input port is at a maximum threshold value; and
setting the maximum threshold value based at least in part on the configuration code.

43. The method of claim 35, further comprising:
maintaining a magnitude of a maximum power point voltage across the input port to within a range of values; and
setting the range of values based at least in part on the configuration code.

44. The method of claim 35, further comprising:
preventing a magnitude of an average voltage across an output port of the MPPT controller from exceeding a maximum threshold value; and
setting the maximum threshold value based at least in part on the configuration code.

45. The method of claim 35, further comprising storing the configuration code in memory of MPPT controller.

46. The method of claim 35, further comprising representing the configuration code at least partially by a configuration of electrical conductors of the MPPT controller.

47. The method of claim 35, further comprising representing the configuration code at least partially by a characteristic of one or more electrical components of the MPPT controller.

48. The method of claim 35, further comprising receiving the configuration code at the MPPT controller from an external source.

49. The method of claim 35, further comprising:
generating a first signal representing a voltage across the input port while a switching circuit of the MPPT controller is in an inactive state; and
determining the configuration code at least partially based on the first signal.

50. The method of claim 49, further comprising:
measuring a temperature at the MPPT controller; and
prior to the step of determining, adjusting the first signal based at least in part on the temperature at the MPPT controller.

51. The method of claim 35, further comprising:
measuring a voltage across the input port while pulling current from the photovoltaic device; and
operating the MPPT controller in a MPPT operating mode if the voltage across the input port exceeds a threshold value.

52. The method of claim 51, further comprising operating the MPPT controller in a bypass operating mode if the voltage across the input port is less than or equal to the threshold value.

53. A method for operating a maximum power point tracking (MPPT) controller adapted to maximize an amount of power extracted from a photovoltaic device electrically coupled to an input port of the MPPT controller, comprising:
determining a configuration code of the MPPT controller, the configuration code representing a current characteristic of the photovoltaic device; and
setting one or more parameters of the MPPT controller based at least in part on the configuration code.

54. The method of claim 53, the current characteristic of the photovoltaic device being a short circuit current rating of the photovoltaic device.

55. The method of claim 54, further comprising:
at least partially controlling the MPPT controller using a closed loop control subsystem; and
setting at least one scaling factor of the closed loop control subsystem based at least in part on the configuration code.

56. The method of claim 55, further comprising:
generating a current signal proportional to current flowing out of an output port of the MPPT controller;
controlling the MPPT controller at least partially based on the current signal; and
scaling the current signal based at least in part on the configuration code.

57. The method of claim 53, further comprising:
preventing a magnitude of current flowing out of an output port of the MPPT controller from exceeding a maximum threshold value; and
setting the maximum threshold value based at least in part on the configuration code.

58. The method of claim 53, further comprising storing the configuration code in memory of MPPT controller.

59. The method of claim 53, further comprising representing the configuration code at least partially by a configuration of electrical conductors of the MPPT controller.

60. The method of claim 53, further comprising representing the configuration code at least partially by a characteristic of one or more electrical components of the MPPT controller.

61. The method of claim 53, further comprising receiving the configuration code at the MPPT controller from an external source.

62. A method for operating a maximum power point tracking (MPPT) controller adapted to maximize an amount of power extracted from a photovoltaic device electrically coupled to an input port of the MPPT controller, comprising:
determining a configuration code of the MPPT controller, the configuration code representing a reverse breakdown characteristic of the photovoltaic device; and
setting one or more parameters of the MPPT controller based at least in part on the configuration code.

63. The method of claim 62, further comprising:
detecting when a voltage across the input port is at a minimum threshold value; and
setting the minimum threshold value based at least in part on the configuration code.

64. The method of claim 62, further comprising:
maintaining a magnitude of a maximum power point voltage across the input port to within a range of values; and
setting the range of values based at least in part on the configuration code.

65. The method of claim 62, further comprising storing the configuration code in memory of MPPT controller.

66. The method of claim 62, further comprising representing the configuration code at least partially by a configuration of electrical conductors of the MPPT controller.

67. The method of claim 62, further comprising representing the configuration code at least partially by a characteristic of one or more electrical components of the MPPT controller.

68. The method of claim 62, further comprising receiving the configuration code at the MPPT controller from an external source.
